(19) United States
(12) Patent Application Publication
(10) Pub. No.: US 2016/0075249 A1
(43) Pub. Date: Mar. 17, 2016

(54) METHODS AND APPARATUS FOR USER AUTHENTICATION IN ELECTRIC VEHICLE WIRELESS CHARGING

(71) Applicant: QUALCOMM Incorporated, San Diego, CA (US)

(72) Inventors: Simon Grabar, Munich (DE); Marck Daniel Gorszwick, Munich (DE); Bernward Dimke, Munich (DE); Karim Mohamed Mansour, Munich (DE)

(21) Appl. No.: 14/488,821

(22) Filed: Sep. 17, 2014

(51) Int. Cl. B60L 11/18

(52) U.S. Cl. CPC B60L 11/1846

(57) ABSTRACT

Methods and apparatus are disclosed for user authentication in electric vehicle wireless charging. In one aspect, a method of authenticating an electric vehicle for wirelessly receiving power from a wireless charging station is provided, including establishing a first communication session with a portable electronic device. The method further includes establishing a second communication session with a controller configured to control charging via the wireless charging station. During the second communication session, the method includes receiving a base pad identifier from a base pad, transmitting the vehicle identifier, base pad identifier, and a request for wirelessly receiving power to the controller and receiving an indication whether charging is authorized based on transmitting the request, the base pad identifier, and the vehicle identifier, the authorization based at least in part on the account identifier associated with the vehicle identifier during the first communication session.

### FIELD

The present disclosure relates generally to wireless power transfer, and more specifically to systems, methods, and apparatus related to user authentication in electric vehicle wireless charging.

### BACKGROUND

Remote systems, such as vehicles, have been introduced that include locomotion power derived from electricity received from an energy storage device such as a battery. For example, hybrid electric vehicles include on-board chargers that use power from vehicle braking and traditional motors to charge the vehicles. Vehicles that are solely electric generally receive the electricity for charging the batteries from other sources. Battery electric vehicles (electric vehicles) are often proposed to be charged through some type of wired alternating current (AC) such as household or commercial AC supply sources. The wired charging connections require cables or other similar connectors that are physically connected to a power supply. Cables and similar connectors may sometimes be inconvenient or cumbersome and have other drawbacks. Wireless charging systems that are capable of transferring power in free space (e.g., via a wireless field) to be used to charge electric vehicles may overcome some of the deficiencies of wired charging solutions.

For public charging stations and public wireless power infrastructure providers, authentication of a user or driver becomes desirable. In some cases, vehicles capable of wireless power charging may be unable to charge at public charging stations since authentication may not be built into the vehicle itself. As such, wireless charging systems and methods that efficiently and effectively facilitate the authentication of a user or driver at a charging station for a vehicle are needed.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

One aspect of the subject matter described in the disclosure provides a method of charging an electric vehicle. The method includes establishing a first communication session with a portable electronic device. During the first communication the method includes receiving an account identifier from the portable electronic device or transmitting a vehicle identifier of the electric vehicle to the portable device. The method further includes establishing a second communication session with a controller configured to control charging via the wireless charging station. During the second communication session, the method includes receiving a base pad identifier from a base pad. During the second communication session, the method further includes transmitting the vehicle identifier, base pad identifier, and a request for wirelessly receiving power to the controller. During the second communication session, the method further includes receiving an indication whether charging is authorized based on transmitting the request, the base pad identifier, and the vehicle identifier, the authorization based at least in part on the account identifier associated with the vehicle identifier during the first communication session.

Another aspect of the subject matter described in this disclosure provides an apparatus for receiving wireless power. The apparatus includes a receiver comprising one or more coils configured to receive wireless power sufficient to charge or power a battery from a charging station via a magnetic field. The apparatus further includes a transceiver configured to establish a first communication session with a portable electronic device. The transceiver further configured to receive an account identifier from the portable electronic device or transmit a vehicle identifier of an electric vehicle to the portable device, during the first communication session. The transceiver further configured to establish a second communication session with a controller configured to control charging via the wireless charging station. The transceiver further configured to receive a base pad identifier from a base pad, transmit the vehicle identifier, base pad identifier, and a request for wirelessly receiving power to the controller, and receive an indication whether charging is authorized.

Yet another aspect of the subject matter described in this disclosure provides an apparatus for receiving wireless power. The apparatus includes means for establishing a first communication session with a portable electronic device. The means for establishing the first communication comprising means for receiving an account identifier from the portable electronic device or means for transmitting a vehicle identifier of an electric vehicle to the portable device, during the first communication session. The apparatus further includes means for establishing a second communication session with a controller configured to control charging via the wireless charging station. The means for establishing the second communication comprising means for receiving a base pad identifier from a base pad. The means for establishing the second communication further comprising means for transmitting the vehicle identifier, base pad identifier, and a request for wirelessly receiving power to the controller. The means for establishing the second communication further comprising means for receiving an indication whether charging is authorized.

Yet another aspect of the subject matter described in this disclosure provides a non-transitory computer readable medium. The medium comprising instructions that when executed cause a processor to perform a method of establishing a first communication session with a portable electronic device. During the first communication, the medium further comprising instructions that when executed cause a processor to perform a method of receiving an account identifier from the portable electronic device or transmitting a vehicle identifier of an electric vehicle to the portable device. The medium further comprising instructions that when executed cause a processor to perform a method of establishing a second communication session with a controller configured to control charging via the wireless charging station. During the second communication session, the medium further comprising instructions that when executed cause a processor to perform a method of receiving a base pad identifier from a base pad. During the second communication session, the medium further comprising instructions that when executed cause a processor to perform a method of transmitting the vehicle identifier, base pad identifier, and a request for wirelessly receiving power to the controller. During the second communication session, the medium further comprising instructions that when executed cause a processor to perform a method of receiving an indication whether charging is authorized based on transmitting the request, the base pad identifier, and the vehicle identifier, the authorization based at least in part on the account identifier associated with the vehicle identifier during the first communication session.

### BRIEF DESCRIPTION OF THE DRAWINGS

FIG. 1 illustrates a diagram of an exemplary wireless power transfer system for charging an electric vehicle, in accordance with an exemplary embodiment of the invention.

FIG. 2 illustrates a schematic diagram of exemplary core components of the wireless power transfer system of FIG. 1.

FIG. 3 illustrates another functional block diagram showing exemplary core and ancillary components of the wireless power transfer system of FIG. 1.

FIG. 4A is a diagram of an exemplary pairing communication between a portable device and a wireless charging infrastructure provider server.

FIG. 4B is a diagram of an exemplary pairing communication between a portable device and an electric vehicle.

FIG. 5 is a diagram of an exemplary wireless communication system.

FIG. 6 is a diagram of an exemplary wireless communication system.

FIG. 7A illustrates a flowchart of an exemplary method of authenticating a user with a portable device.

FIG. 7B illustrates a flowchart of an exemplary method of authenticating a user with a portable device.

FIG. 8 illustrates a flowchart of an exemplary method of authenticating a vehicle for wirelessly receiving power from a wireless charging station.

FIG. 9 is a functional block diagram of a wireless power apparatus, in accordance with an exemplary embodiment of the invention.

The various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

The detailed description set forth below in connection with the appended drawings is intended as a description of exemplary embodiments of the invention and is not intended to represent the only embodiments in which the invention may be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the invention. In some instances, some devices are shown in block diagram form.

Wirelessly transferring power may refer to transferring any form of energy associated with electric fields, magnetic fields, electromagnetic fields, or otherwise from a transmitter to a receiver without the use of physical electrical conductors (e.g., power may be transferred through free space). The power output into a wireless field (e.g., a magnetic field) may be received, captured by, or coupled by a “receiving coil” to achieve power transfer.

An electric vehicle is used herein to describe a remote system, an example of which is a vehicle that includes, as part of its locomotion capabilities, electrical power derived from a chargeable energy storage device (e.g., one or more rechargeable electrochemical cells or other type of battery). As non-limiting examples, some electric vehicles may be hybrid electric vehicles that include electric motors in addition to a traditional combustion engine for direct locomotion or for charging the vehicle's battery. Other electric vehicles may draw all locomotion ability from electrical power. An electric vehicle is not limited to an automobile and may include motorcycles, carts, scooters, and the like. By way of example and not limitation, a remote system is described herein in the form of an electric vehicle (EV). Furthermore, other remote systems that may be at least partially powered using a chargeable energy storage device are also contemplated (e.g., electronic devices such as personal computing devices and the like).

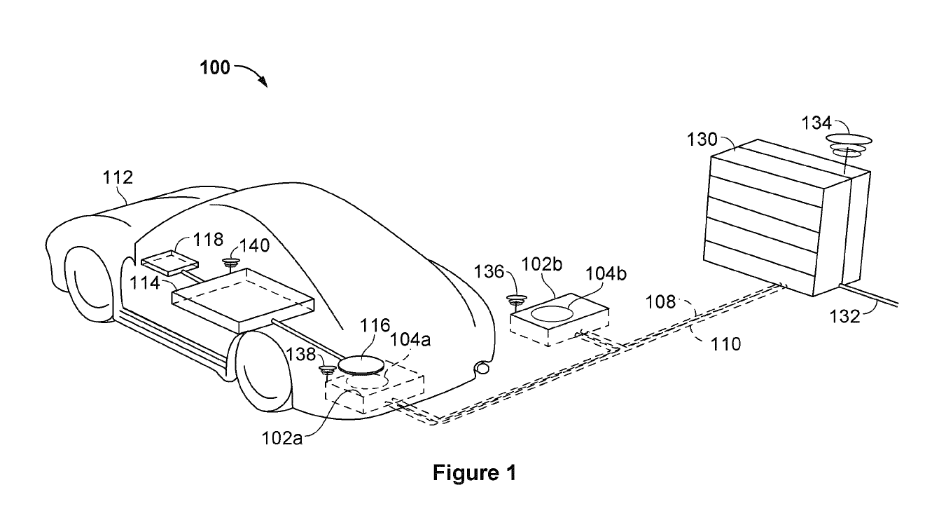

FIG. 1 is a diagram of an exemplary wireless power transfer system 100 for charging an electric vehicle 112, in accordance with an exemplary embodiment of the invention. The wireless power transfer system 100 enables charging of an electric vehicle 112 while the electric vehicle 112 is parked near a base wireless charging system 102a. Spaces for two electric vehicles are illustrated in a parking area to be parked over corresponding base wireless charging system 102a and 102b. In some embodiments, a local distribution center 130 may be connected to a power backbone 132 and configured to provide an alternating current (AC) or a direct current (DC) supply through a power link 110 to the base wireless charging system 102a. The base wireless charging system 102a also includes a base system induction coil 104a for wirelessly transferring or receiving power and an antenna 138. An electric vehicle 112 may include a battery unit 118, an electric vehicle induction coil 116, an electric vehicle wireless charging system 114, and an antenna 140. The electric vehicle induction coil 116 may interact with the base system induction coil 104a, for example, via a region of the electromagnetic field generated by the base system induction coil 104a.

In some exemplary embodiments, the electric vehicle induction coil 116 may receive power when the electric vehicle induction coil 116 is located in an energy field produced by the base system induction coil 104a. The field corresponds to a region where energy output by the base system induction coil 104a may be captured by an electric vehicle induction coil 116. For example, the energy output by the base system induction coil 104a may be at a level sufficient to charge or power the electric vehicle 112 (e.g., to charge the battery unit 118). In some cases, the field may correspond to the “near field” of the base system induction coil 104a. The near-field may correspond to a region in which there are strong reactive fields resulting from the currents and charges in the base system induction coil 104a that do not radiate power away from the base system induction coil 104a. In some cases the near-field may correspond to a region that is within about ½π of wavelength of the base system induction coil 104a (and vice versa for the electric vehicle induction coil 116) as will be further described below.

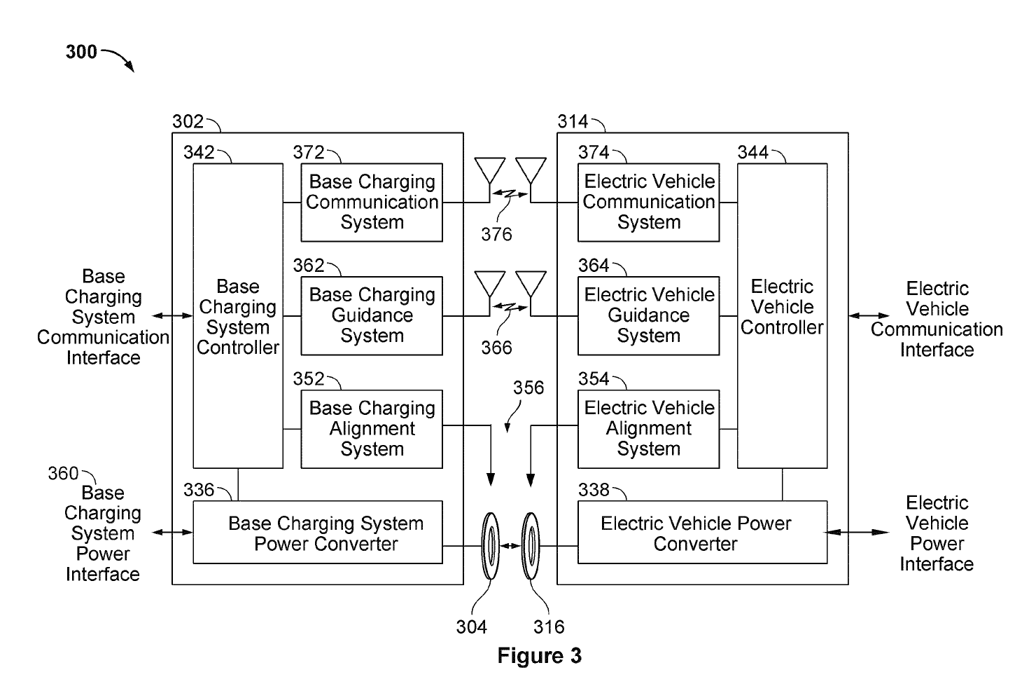

Local distribution center 130 may include Base Charging System Controller 342 (described with reference to FIG. 3 below) and may be configured to communicate with external sources (e.g., a power grid) via a communication backhaul 134, and with the base wireless charging system 102a via a communication link 108.

Base wireless charging systems 102a and 102b may be configured to communicate with the electric vehicle wireless charging system 114 via antennas 136 and 138. For example, the wireless charging system 102a may communicate with the electric vehicle wireless charging system 114 using a communication channel between antennas 138 and 140. The communication channels may be any type of communication channels such as, for example, Bluetooth, zigbee, cellular, magnetic field signals, wireless local area network (WLAN), etc.

In some embodiments the electric vehicle induction coil 116 may be aligned with the base system induction coil 104a and, therefore, disposed within a near-field region simply by the driver positioning the electric vehicle 112 correctly relative to the base system induction coil 104a. In other embodiments, the driver may be given visual feedback, auditory feedback, or combinations thereof to determine when the electric vehicle 112 is properly placed for wireless power transfer. In yet other embodiments, the electric vehicle 112 may be positioned by an autopilot system, which may move the electric vehicle 112 back and forth (e.g., in zig-zag movements) until an alignment error has reached a tolerable value. This may be performed automatically and autonomously by the electric vehicle 112 without or with only minimal driver intervention provided that the electric vehicle 112 is equipped with a servo steering wheel, ultrasonic sensors, and intelligence to adjust the vehicle. In still other embodiments, the electric vehicle induction coil 116, the base system induction coil 104a, or a combination thereof may have functionality for displacing and moving the induction coils 116 and 104a relative to each other to more accurately orient them and develop more efficient coupling therebetween.

The base wireless charging system 102a may be located in a variety of locations. As non-limiting examples, some suitable locations include a parking area at a home of the electric vehicle 112 owner, parking areas reserved for electric vehicle wireless charging modeled after conventional petroleum-based filling stations, and parking lots at other locations such as shopping centers and places of employment.

Charging electric vehicles wirelessly may provide numerous benefits. For example, charging may be performed automatically, virtually without driver intervention and manipulations thereby improving convenience to a user. There may also be no exposed electrical contacts and no mechanical wear out, thereby improving reliability of the wireless power transfer system 100. Manipulations with cables and connectors may not be needed, and there may be no cables, plugs, or sockets that may be exposed to moisture and water in an outdoor environment, thereby improving safety. There may also be no sockets, cables, and plugs visible or accessible, thereby reducing potential vandalism of power charging devices. Further, since an electric vehicle 112 may be used as distributed storage devices to stabilize a power grid, a docking-to-grid solution may be used to increase availability of vehicles for Vehicle-to-Grid (V2G) operation.

A wireless power transfer system 100 as described with reference to FIG. 1 may also provide aesthetical and non-impedimental advantages. For example, there may be no charge columns and cables that may be impedimental for vehicles and/or pedestrians.

As a further explanation of the vehicle-to-grid capability, the wireless power transmit and receive capabilities may be configured to be reciprocal such that the base wireless charging system 102a transfers power to the electric vehicle 112 and the electric vehicle 112 transfers power to the base wireless charging system 102a e.g., in times of energy shortfall. This capability may be useful to stabilize the power distribution grid by allowing electric vehicles to contribute power to the overall distribution system in times of energy shortfall caused by over demand or shortfall in renewable energy production (e.g., wind or solar).

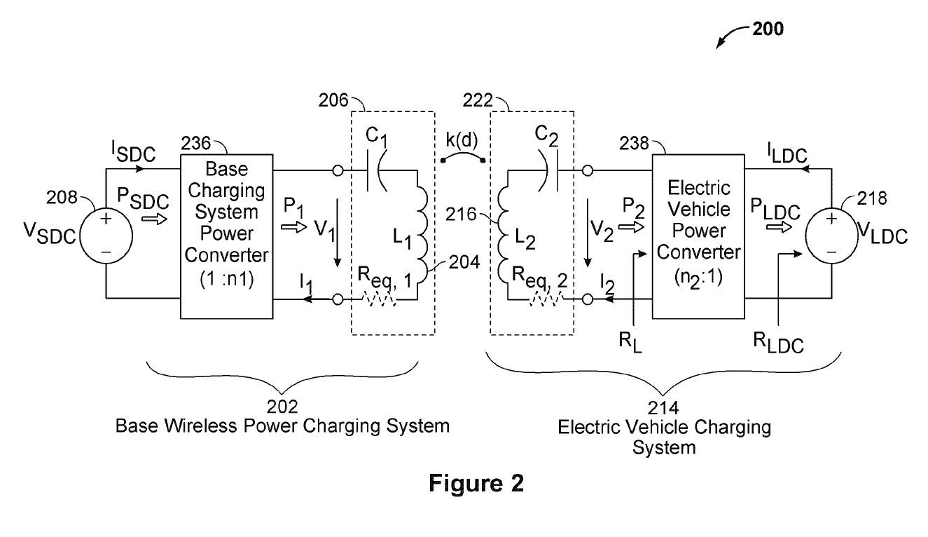

FIG. 2 is a schematic diagram of exemplary components of the wireless power transfer system 100 of FIG. 1. As shown in FIG. 2, the wireless power transfer system 200 may include a base system transmit circuit 206 including a base system induction coil 204 having an inductance L₁. The wireless power transfer system 200 further includes an electric vehicle receive circuit 222 including an electric vehicle induction coil 216 having an inductance L₂. Embodiments described herein may use capacitively loaded wire loops (i.e., multi-turn coils) forming a resonant structure that is capable of efficiently coupling energy from a primary structure (transmitter) to a secondary structure (receiver) via a magnetic or electromagnetic near field if both primary and secondary are tuned to a common resonant frequency. The coils may be used for the electric vehicle induction coil 216 and the base system induction coil 204. Using resonant structures for coupling energy may be referred to “magnetic coupled resonance,” “electromagnetic coupled resonance,” and/or “resonant induction.” The operation of the wireless power transfer system 200 will be described based on power transfer from a base wireless power charging system 202 to an electric vehicle 112, but is not limited thereto. For example, as discussed above, the electric vehicle 112 may transfer power to the base wireless charging system 102a.

With reference to FIG. 2, a power supply 208 (e.g., AC or DC) supplies power P_{SDC} to the base wireless power charging system 202 to transfer energy to an electric vehicle 112. The base wireless power charging system 202 includes a base charging system power converter 236. The base charging system power converter 236 may include circuitry such as an AC/DC converter configured to convert power from standard mains AC to DC power at a suitable voltage level, and a DC/low frequency (LF) converter configured to convert DC power to power at an operating frequency suitable for wireless high power transfer. The base charging system power converter 236 supplies power P₁ to the base system transmit circuit 206 including the capacitor C₁ in series with the base system induction coil 204 to emit an electromagnetic field at a desired frequency. The capacitor C₁ may be provided to form a resonant circuit with the base system induction coil 204 that resonates at a desired frequency. The base system induction coil 204 receives the power P₁ and wirelessly transmits power at a level sufficient to charge or power the electric vehicle 112. For example, the power level provided wirelessly by the base system induction coil 204 may be on the order of kilowatts (kW) (e.g., anywhere from 1 kW to 110 kW or higher or lower).

The base system transmit circuit 206 including the base system induction coil 204 and electric vehicle receive circuit 222 including the electric vehicle induction coil 216 may be tuned to substantially the same frequencies and may be positioned within the near-field of an electromagnetic field transmitted by one of the base system induction coil 204 and the electric vehicle induction coil 116. In this case, the base system induction coil 204 and electric vehicle induction coil 116 may become coupled to one another such that power may be transferred to the electric vehicle receive circuit 222 including capacitor C₂ and electric vehicle induction coil 116. The capacitor C₂ may be provided to form a resonant circuit with the electric vehicle induction coil 216 that resonates at a desired frequency. Element k(d) represents the mutual coupling coefficient resulting at coil separation. Equivalent resistances R_{eq,1} and R_{eq,2} represent the losses that may be inherent to the induction coils 204 and 216 and the anti-reactance capacitors C₁ and C₂. The electric vehicle receive circuit 222 including the electric vehicle induction coil 316 and capacitor C₂ receives power P₂ and provides the power P₂ to an electric vehicle power converter 238 of an electric vehicle charging system 214.

The electric vehicle power converter 238 may include, among other things, a LF/DC converter configured to convert power at an operating frequency back to DC power at a voltage level matched to the voltage level of an electric vehicle battery unit 218. The electric vehicle power converter 238 may provide the converted power P_{LDC} to charge the electric vehicle battery unit 218. The power supply 208, base charging system power converter 236, and base system induction coil 204 may be stationary and located at a variety of locations as discussed above. The battery unit 218, electric vehicle power converter 238, and electric vehicle induction coil 216 may be included in an electric vehicle charging system 214 that is part of electric vehicle 112 or part of the battery pack (not shown). The electric vehicle charging system 214 may also be configured to provide power wirelessly through the electric vehicle induction coil 216 to the base wireless power charging system. 202 to feed power back to the grid. Each of the electric vehicle induction coil 216 and the base system induction coil 204 may act as transmit or receive induction coils based on the mode of operation.

While not shown, the wireless power transfer system 200 may include a load disconnect unit (LDU) to safely disconnect the electric vehicle battery unit 218 or the power supply 208 from the wireless power transfer system 200. For example, in case of an emergency or system failure, the LDU may be triggered to disconnect the load from the wireless power transfer system 200. The LDU may be provided in addition to a battery management system for managing charging to a battery, or it may be part of the battery management system.

Further, the electric vehicle charging system 214 may include switching circuitry (not shown) for selectively connecting and disconnecting the electric vehicle induction coil 216 to the electric vehicle power converter 238. Disconnecting the electric vehicle induction coil 216 may suspend charging and also may adjust the “load” as “seen” by the base wireless charging system 102a (acting as a transmitter), which may be used to “cloak” the electric vehicle charging system 114 (acting as the receiver) from the base wireless charging system 102a. The load changes may be detected if the transmitter includes the load sensing circuit. Accordingly, the transmitter, such as a base wireless charging system 202, may have a mechanism for determining when receivers, such as an electric vehicle charging system 114, are present in the near-field of the base system induction coil 204.

As described above, in operation, assuming energy transfer towards the vehicle or battery, input power is provided from the power supply 208 such that the base system induction coil 204 generates a field for providing the energy transfer. The electric vehicle induction coil 216 couples to the radiated field and generates output power for storage or consumption by the electric vehicle 112. As described above, in some embodiments, the base system induction coil 204 and electric vehicle induction coil 116 are configured according to a mutual resonant relationship such that the resonant frequency of the electric vehicle induction coil 116 and the resonant frequency of the base system induction coil 204 are very close or substantially the same. Transmission losses between the base wireless power charging system 202 and electric vehicle charging system 214 are minimal when the electric vehicle induction coil 216 is located in the near-field of the base system induction coil 204.

As stated, an efficient energy transfer occurs by coupling a large portion of the energy in the near field of a transmitting induction coil to a receiving induction coil rather than propagating most of the energy in an electromagnetic wave to the far-field. When in the near field, a coupling mode may be established between the transmit induction coil and the receive induction coil. The area around the induction coils where this near field coupling may occur is referred to herein as a near field coupling mode region.

While not shown, the base charging system power converter 236 and the electric vehicle power converter 238 may both include an oscillator, a driver circuit such as a power amplifier, a filter, and a matching circuit for efficient coupling with the wireless power induction coil. The oscillator may be configured to generate a desired frequency, which may be adjusted in response to an adjustment signal. The oscillator signal may be amplified by a power amplifier with an amplification amount responsive to control signals. The filter and matching circuit may be included to filter out harmonics or other unwanted frequencies and match the impedance of the power conversion module to the wireless power induction coil. The power converters 236 and 238 may also include a rectifier and switching circuitry to generate a suitable power output to charge the battery.

The electric vehicle induction coil 216 and base system induction coil 204 as described throughout the disclosed embodiments may be referred to or configured as “loop” antennas, and more specifically, multi-turn loop antennas. The induction coils 204 and 216 may also be referred to herein or be configured as “magnetic” antennas. The term “coils” is intended to refer to a component that may wirelessly output or receive energy four coupling to another “coil.” The coil may also be referred to as an “antenna” of a type that is configured to wirelessly output or receive power. As used herein, coils 204 and 216 are examples of “power transfer components” of a type that are configured to wirelessly output, wirelessly receive, and/or wirelessly relay power. Loop (e.g., multi-turn loop) antennas may be configured to include an air core or a physical core such as a ferrite core. An air core loop antenna may allow the placement of other components within the core area. Physical core antennas including ferromagnetic or ferromagnetic materials may allow development of a stronger electromagnetic field and improved coupling.

As discussed above, efficient transfer of energy between a transmitter and receiver occurs during matched or nearly matched resonance between a transmitter and a receiver. However, even when resonance between a transmitter and receiver are not matched, energy may be transferred at a lower efficiency. Transfer of energy occurs by coupling energy from the near field of the transmitting induction coil to the receiving induction coil residing within a region (e.g., within a predetermined frequency range of the resonant frequency, or within a predetermined distance of the near-field region) where this near field is established rather than propagating the energy from the transmitting induction coil into free space.

A resonant frequency may be based on the inductance and capacitance of a transmit circuit including an induction coil (e.g., the base system induction coil 204) as described above. As shown in FIG. 2, inductance may generally be the inductance of the induction coil, whereas, capacitance may be added to the induction coil to create a resonant structure at a desired resonant frequency. As a non-limiting example, as shown in FIG. 2, a capacitor may be added in series with the induction coil to create a resonant circuit (e.g., the base system transmit circuit 206) that generates an electromagnetic field. Accordingly, for larger diameter induction coils, the value of capacitance needed to induce resonance may decrease as the diameter or inductance of the coil increases. Inductance may also depend on a number of turns of an induction coil. Furthermore, as the diameter of the induction coil increases, the efficient energy transfer area of the near field may increase. Other resonant circuits are possible. As another non limiting example, a capacitor may be placed in parallel between the two terminals of the induction coil (e.g., a parallel resonant circuit). Furthermore an induction coil may be designed to have a high quality (Q) factor to improve the resonance of the induction coil. For example, the Q factor may be 300 or greater.

As described above, according to some embodiments, coupling power between two induction coils that are in the near field of one another is disclosed. As described above, the near field may correspond to a region around the induction coil in which electromagnetic fields exist but may not propagate or radiate away from the induction coil. Near-field coupling-mode regions may correspond to a volume that is near the physical volume of the induction coil, typically within a small fraction of the wavelength. According to some embodiments, electromagnetic induction coils, such as single and multi-turn loop antennas, are used for both transmitting and receiving since magnetic near field amplitudes in practical embodiments tend to be higher for magnetic type coils in comparison to the electric near fields of an electric type antenna (e.g., a small dipole). This allows for potentially higher coupling between the pair. Furthermore, “electric” antennas (e.g., dipoles and monopoles) or a combination of magnetic and electric antennas may be used.

FIG. 3 is a functional block diagram showing exemplary components of wireless power transfer system 300, which may be employed in wireless power transfer system 100 of FIG. 1 and/or wireless power transfer system 200 of FIG. 2. The wireless power transfer system 300 illustrates a communication link 376, a guidance link 366, using, for example, a magnetic field signal for determining a position or direction, an alignment mechanism 356 e.g. to mechanically move one of the base system induction coil 304 and the vehicle system induction coil 316, and base charging and electric vehicle charging alignment systems 352, 354 for the base system induction coil 304 and electric vehicle induction coil 316. As described above with reference to FIG. 2, when energy flows towards the electric vehicle 112, in FIG. 3 a base charging system power interface 348 may be configured to provide power to a base charging system power converter 336 from a power source, such as an AC or DC power supply (not shown). The base charging system power converter 336 may receive AC or DC power from the base charging system power interface 348 to excite the base system induction coil 304 at or near its resonant frequency. The electric vehicle induction coil 316, when in the near field coupling-mode region, may receive energy from the near field coupling mode region to oscillate at or near the resonant frequency. The electric vehicle power converter 338 converts the oscillating signal from the electric vehicle induction coil 316 to a power signal suitable for charging a battery via the electric vehicle power interface.

The base wireless power charging system 302 includes a base charging system controller 342 and the electric vehicle charging system 314 includes an electric vehicle controller 344. The base charging system controller 342 may include a supply equipment communication controller (SECC) to other systems (not shown) such as, for example, a computer, and a power distribution center, or a smart power grid. The electric vehicle controller 344 may include an electric vehicle communication controller (EVCC) to other systems (not shown) such as, for example, an on-board computer on the vehicle, other battery charging controller, other electronic systems within the vehicles, and remote electronic systems.

The base charging system controller 342 and electric vehicle controller 344 may include subsystems or modules for specific application with separate communication channels. These communications channels may be separate physical channels or separate logical channels. As non-limiting examples, a base charging alignment system 352 may communicate with an electric vehicle charging alignment system 354 through communication link 376 to provide a feedback mechanism for more closely aligning the base system induction coil 304 and electric vehicle induction coil 316, e.g. mechanically (kinematic alignment), autonomously by the vehicle or with operator assistance as described herein. Similarly, a base charging guidance system 362 may communicate with an electric vehicle guidance system 364 through communication link 376 and also using a guidance link 366 to provide a feedback mechanism to guide an operator to the charging spot and in aligning the base system induction coil 304 and electric vehicle induction coil 316. In addition, there may be separate general-purpose communication channels via communications link 376 supported by base charging communication system 372 and electric vehicle communication controller (EVCC) 374 for communicating other information between the base wireless power charging system 302 and the electric vehicle charging system 314. This information may include information about electric vehicle characteristics, battery characteristics, charging status, and power capabilities of both the base wireless power charging system 302 and the electric vehicle charging system 314, as well as maintenance and diagnostic data for the electric vehicle. These communication channels may be separate logical channels or separate physical communication channels such as, for example, WLAN, Bluetooth, zigbee, cellular, etc.

Electric vehicle controller 344 may also include a battery management system (BMS) (not shown) that manages charge and discharge of the electric vehicle principal and/or auxiliary battery. As discussed herein, some embodiments of electric vehicle controller 344 may employ a parking assistance system based on microwave, ultrasonic radar, or magnetic vectoring principles, a brake system configured to perform a semi-automatic parking operation, and a steering wheel servo system configured to assist with a largely automated parking “park by wire” that may provide higher parking accuracy and provide sufficient alignment between base system and electric vehicle induction coils 304 and 316. Further, electric vehicle controller 344 may be configured to communicate with electronics of the electric vehicle 112. For example, electric vehicle controller 344 may be configured to communicate with visual output devices (e.g., a dashboard display), acoustic/audio output devices (e.g., buzzer, speakers), mechanical input devices (e.g., keyboard, touch screen, and pointing devices such as joystick, trackball, etc.), audio input devices (e.g., microphone with electronic voice recognition); and portable devices (e.g., smartphones, tablets, etc.).

Furthermore, the wireless power transfer system 300 may include detection and sensor systems (not shown). For example, the wireless power transfer system 300 may include sensors for use with systems to properly guide the driver or the vehicle to the charging spot, sensors to mutually align the induction coils with the required separation/coupling, sensors to detect objects that may obstruct the electric vehicle induction coil 316 from moving to a particular height and/or position to achieve coupling, and safety sensors for use with systems to perform a reliable, damage free, and safe operation of the system. For example, a safety sensor may include a sensor for detection of presence of animals or children approaching the base system and electric vehicle induction coils 304, 316 beyond a safety radius, detection of metal objects near the base system induction coil 304 that may be heated up (induction heating), and detection of hazardous events such as incandescent objects on the base system induction coil 304.

The wireless power transfer system 300 may also support plug-in charging via a wired connection. A wired charge port may integrate the outputs of the two different chargers prior to transferring power to or from the electric vehicle. Switching circuits may provide the functionality as needed to support both wireless charging and charging via a wired charge port.

To communicate between a base wireless power charging system 302 and an electric vehicle charging system 314, the wireless power transfer system 300 may use in-band signaling via base system and electric vehicle induction coils 304, 316 and/or out-of-band signaling via communications systems, e.g., RF data modem (e.g., Ethernet over radio in an unlicensed band). The out-of-band communication may provide sufficient bandwidth for the allocation of value-add services to the vehicle user/owner. A low depth amplitude or phase modulation of the wireless power carrier may serve as an in-band signaling system with minimal interference.

In addition, some communication may be performed via the wireless power link without using specific communications antennas. For example, the base system and electric vehicle induction coils 304 and 316 may also be configured to act as wireless communication transmitters. Thus, some embodiments of the base wireless power charging system 302 may include a controller (not shown) for enabling keying type protocol on the wireless power path. By keying the transmit power level (amplitude shift keying) at predefined intervals with a predefined protocol, the receiver may detect a serial communication from the transmitter. The base charging system power converter 336 may include a load sensing circuit (not shown) for detecting the presence or absence of active electric vehicle receivers in the vicinity of the near field generated by the base system induction coil 304. By way of example, a load sensing circuit monitors the current flowing to the power amplifier, which is affected by the presence or absence of active receivers in the vicinity of the near field generated by base system induction coil 304. Detection of changes to the loading on the power amplifier may be monitored by the base charging system controller 342 for use in determining whether to enable the oscillator for transmitting energy, to communicate with an active receiver, or a combination thereof.

To enable wireless high power transfer, some embodiments may be configured to transfer power at a frequency in the range from 10-150 kHz. This low frequency coupling may allow highly efficient power conversion that may be achieved using solid state devices. In addition, there may be less coexistence issues with radio systems compared to other bands.

Embodiments described herein relate to user authentication for wireless charging. Public charging may require an authentication among a user of the electric vehicle 112, the electric vehicle 112, and the charging station (e.g., base wireless charging system 102) before the charging station provides power to the electric vehicle 112. If the authentication is successful, the battery unit 118 of the electric vehicle 112 may be charged via a base system induction coil 104. If, however, the authentication fails, then charging may not occur or may be terminated.

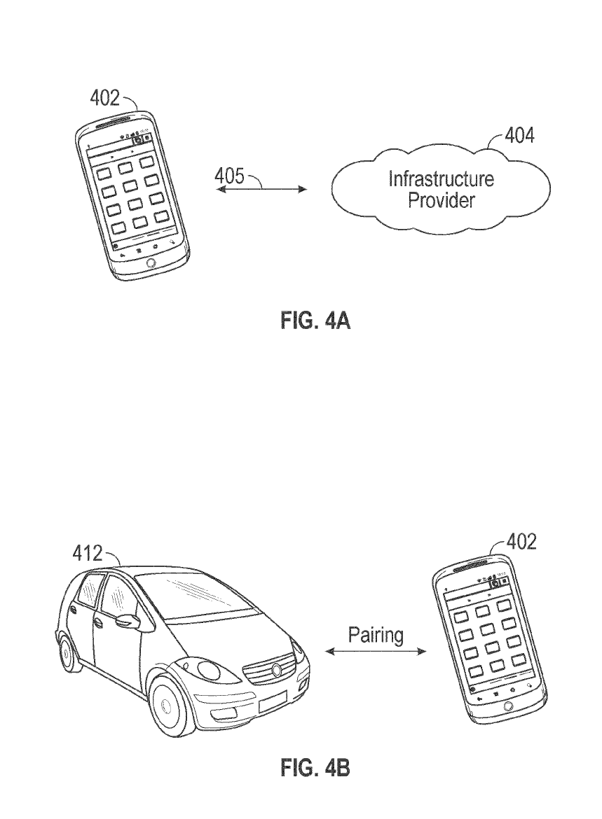

User authentication described herein includes authentication via a mobile phone or portable device. In some embodiments, a user may install an application on the user's portable device (e.g., smart phone). FIG. 4A is a diagram of an exemplary pairing communication between a user's portable device 402 and a wireless charging infrastructure provider server 404. The portable device 402 may comprise an account identifier (ID) for identifying an account of a user or multiple users of the electric vehicle with the infrastructure provider or other party. In some embodiments, the account ID may comprise a phone identifier (e.g., model/serial number or unique identifier). A wireless charging infrastructure provider may provide the application to the user via an application store such as the Apple App Store, Windows Store, Google Play store, etc. The user may then open an account at a selected infrastructure provider via the application on the portable device 402 or may have an account previously set up with the infrastructure provider. As shown in FIG. 4A, the user may securely connect the portable device 402 with a created account or contract of the infrastructure provider. The account established with the wireless charging infrastructure provider server 404 may pair with the account ID of the portable device 402 via a communication link 405. Pairing data can be stored in a memory of the portable device 402, at the wireless charging infrastructure provider server 404, or both. In some embodiments, the account ID can be code generated from the application or account number.

User authentication may also require pairing between an electric vehicle (e.g., electric vehicle 112) and the user's portable device (e.g., portable device 402). FIG. 4B is a diagram of an exemplary pairing communication between a user's portable device 402 and an electric vehicle 412. A user may pair the portable device 402 account ID with the electric vehicle 412 vehicle identifier (ID) by any one of possible options. For example, the portable device 402 may automatically receive the vehicle ID via a wireless communication (e.g., Bluetooth) from the electric vehicle 412 infotainment or communication system. In another embodiment, the user may manually enter the vehicle ID into the portable device 402 application (e.g., manual entry, scan VIN code, etc.) In some embodiments, the electric vehicle 412 may automatically receive the account ID from the portable device 402 via a wireless communication (e.g., Bluetooth). In other embodiments, the user may manually enter the account ID into the electric vehicle 412 user interface or infotainment system. In some embodiments, more than one vehicle ID may be stored in a memory of the portable device 402 representing each vehicle the user is driving. Similarly, more than one account ID may be stored in a memory of the electric vehicle 412 representing each user authorized to use the electric vehicle 412.

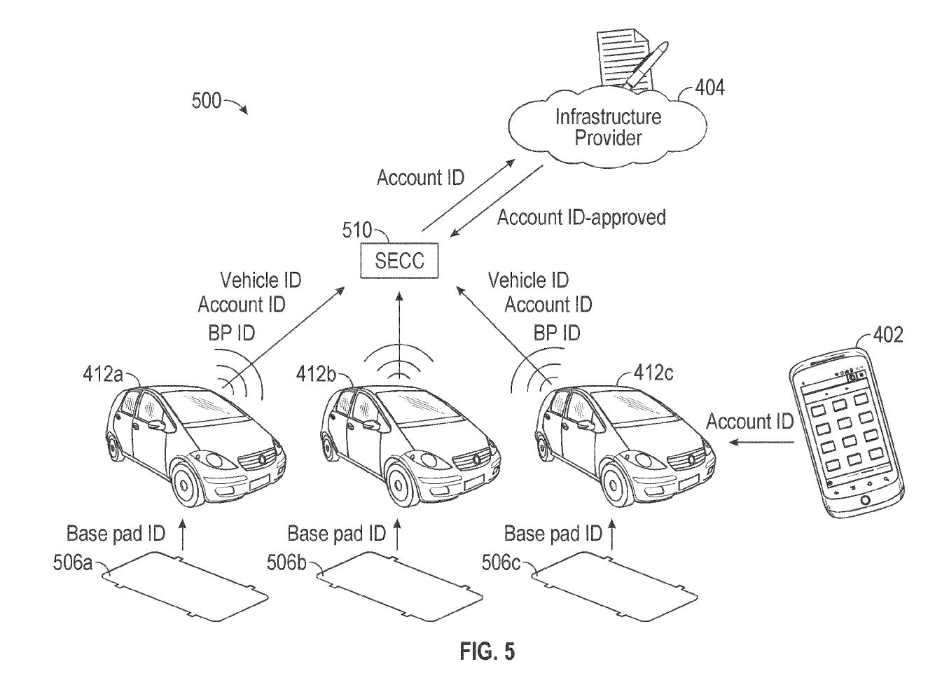

FIG. 5 is a diagram of an exemplary wireless communication system 500. The wireless communication system 500 comprises base pads 506A-C, electric vehicles 412A-C, portable device 402, a supply equipment communication controller (SECC) 510, and the infrastructure provider server 404. In some embodiments, the user may enter the electric vehicle 412C and the portable device 402 may pair with the electric vehicle 412C in a variety of ways, as described with respect to FIG. 4B above. The user may then park the electric vehicle 412C at a charging station comprising the base pad 506C and request to charge the electric vehicle 412C. As shown in FIG. 5, the electric vehicle 412C receives the account ID of the portable device 402 and a base pad ID from the base pad 506C. The electric vehicle 412C sends following data to SECC 510: the vehicle ID of electric vehicle 412C; the account ID stored in the portable device 402; and a base pad ID from the base pad 506C accrued by a proximity device (e.g., Magnetic vectoring or Bluetooth). Next the SECC 510 sends the account ID to infrastructure provider server 404. The infrastructure provider server 404 then checks for a valid contract mapped to the account ID of the portable device 402. If the user has a valid contract or account associated with the account ID, the infrastructure provider server 404 may approve the charging request associated with the account ID to SECC 510. The SECC 510 may then map the vehicle ID, base pad ID and account ID received from the electric vehicle 412C and the portable device 402 to turn on the power of the base pad 506C corresponding to the base pad ID to charge the electric vehicle 412C. The base pad 506C then provides wireless power to the electric vehicle 412C sufficient to charge a battery of the electric vehicle 412C or sufficient to power the electric vehicle 412C.

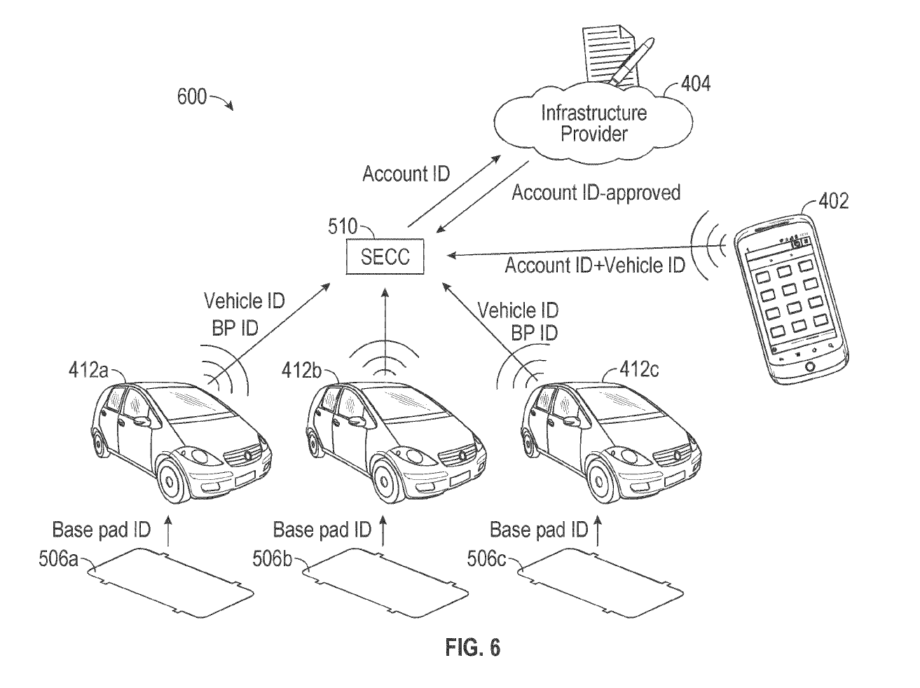

FIG. 6 is a diagram of an exemplary wireless communication system 600. The wireless communication system 600 illustrated in FIG. 6 is similar to and adapted from the wireless charging system 500 illustrated in FIG. 5. Elements common to both share common reference indicia, and only differences between the systems 500 and 600 are described herein for the sake of brevity.

In some embodiments, the portable device 402 may receive the vehicle ID from the electric vehicle 412C when the user enters the electric vehicle 412C. The user may then park the electric vehicle 412C at a charging station comprising the base pad 506C and request to charge the electric vehicle 412C. As shown in FIG. 6, the portable device 402 sends its account ID and the vehicle ID received from electric vehicle 412C to the SECC 510. The electric vehicle 412C receives the base pad ID from the base pad 506C and sends the vehicle ID of electric vehicle 412C and the base pad ID from the base pad 506C accrued by a proximity device (e.g., Magnetic vectoring or Bluetooth). Next the SECC 510 sends the account ID to infrastructure provider server 404. The infrastructure provider server 404 then checks for a valid contract mapped to the account ID of the portable device 402. If the user has a valid contract or account associated with the account ID, the infrastructure provider server 404 may approve the charging request associated with the account ID to SECC 510. The SECC 510 may then map the vehicle ID, base pad ID and account ID received from the electric vehicle 412C and the portable device 402 to turn on the power of the base pad 506C corresponding to the base pad ID electric vehicle 412C.

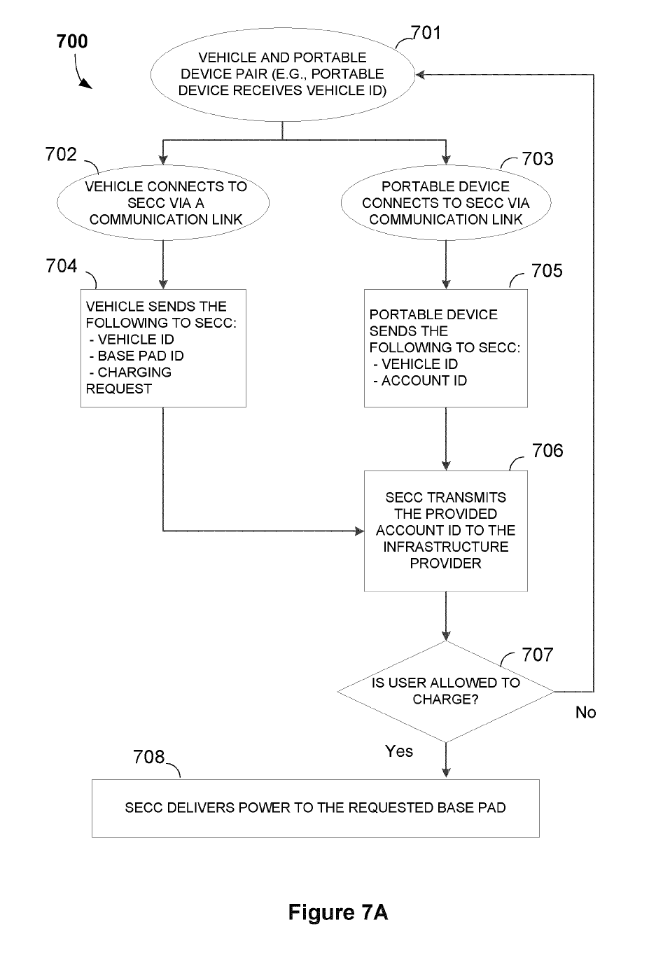

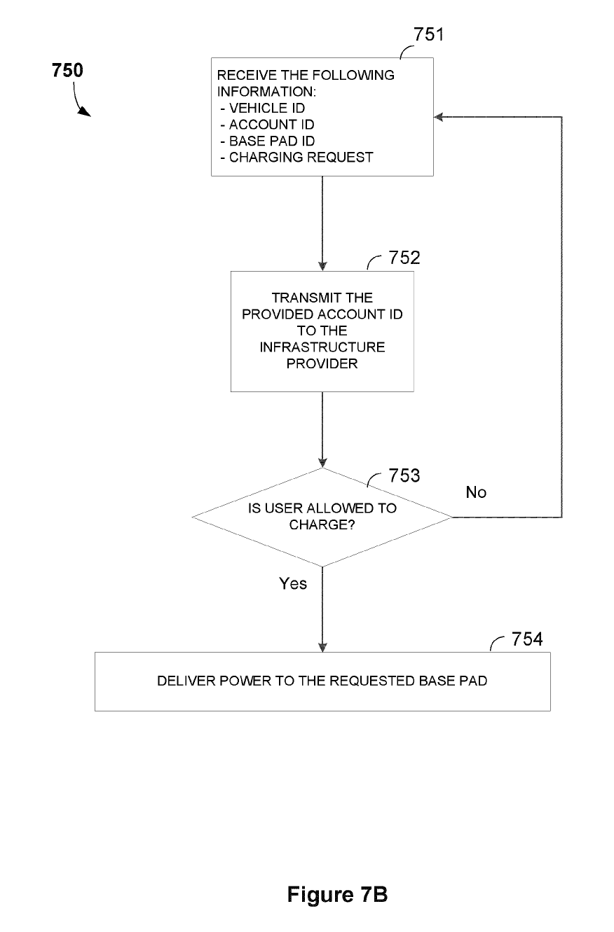

FIG. 7A illustrates a flowchart 700 of an exemplary method of authenticating a user with a portable device. At block 701, the method begins by pairing a portable device (e.g., portable device 402) with an electric vehicle (e.g., electric vehicle 412C). For example, pairing may include establishing a first communication session with the portable device 402. In block 701, the portable device receives the vehicle ID from the electric vehicle 412. At block 702, the electric vehicle connects to a communication controller (e.g., SECC 510) via a first communication link (e.g., Bluetooth, WiFi, etc.) during a later (second) communication session when a potential charging opportunity is detected. At block 703, the portable device connects to the communication controller (e.g., SECC 510) via a second communication link (e.g., Bluetooth, WiFi, etc.). In some embodiments, the electric vehicle and the portable device may connect to the communication controller via the same or different communication link. At block 704, the electric vehicle sends the vehicle ID, the base pad ID, and a charging request to the SECC 510. In some embodiments, the charging request includes a requested base pad associated with the base pad ID. Additionally, at block 705, the portable device 402 sends the vehicle ID and the account ID to the SECC 510.

At block 706, SECC 510 sends the account ID received from the portable device to the infrastructure provider (e.g., infrastructure provider 404). At block 707, the infrastructure provider determines whether the user is allowed to charge. If the account ID of the portable device matches an account on the infrastructure provider server, then the user may be allowed to charge and the method proceeds to block 708. If the account ID associated with the portable device 402 does not match an account at the infrastructure provider server 404, then the method may return to block 701. At block 708, the SECC 510 receives a message confirming that the account ID associated with the user is authorized to receive charging from the base pad associated with the base pad ID. The SECC 510 then delivers power to the requested base pad (e.g., base pad 506C).

FIG. 7B illustrates a flowchart 750 of an exemplary method of authenticating a user with a portable device. At block 751, the method begins when a communication controller (e.g., SECC 510) receives a vehicle ID of an electric vehicle (e.g., electric vehicle 412C), an account ID indicative of a user of a portable device (e.g., portable device 402), a base pad ID of a base pad of a charging station (e.g., base pad 506C) and a charging request to charge the electric vehicle. In some embodiments, the SECC 510 may receive this information from one or more devices. For example, in some embodiments, the SECC 510 may receive the vehicle ID, base pad ID, and charging request from the electric vehicle 412C and may receive the account ID from the portable device 402. In some embodiments, the SECC 510 may receive all the information from electric vehicle 412C or portable device 402. In some embodiments, the SECC 510 may receive the account ID from the portable device 402, the base pad ID from the base pad 506C, and the vehicle ID and charging request from the electric vehicle 412C, however, other combinations are also possible.

At block 752, the SECC 510 sends the account ID received from the portable device 402 to the infrastructure provider (e.g., infrastructure provider server 404). At block 753, the SECC 510 determines whether the user is allowed to charge. In some embodiments, the SECC 510 receives an indication from the infrastructure provider server 404 whether the account ID matches an account on the infrastructure provider server 404. If the account ID of the portable device matches an account on the infrastructure provider server 404, then the user may be allowed to charge and the method proceeds to block 754. If the account ID of the portable device does not match an account at the infrastructure provider server, then the method may return to block 751. At block 754, the SECC 510 receives a message confirming that the account ID associated with the user is authorized to receive charging from the base pad associated with the base pad ID. The SECC 510 then delivers power to the requested base pad (e.g., base pad 506C).

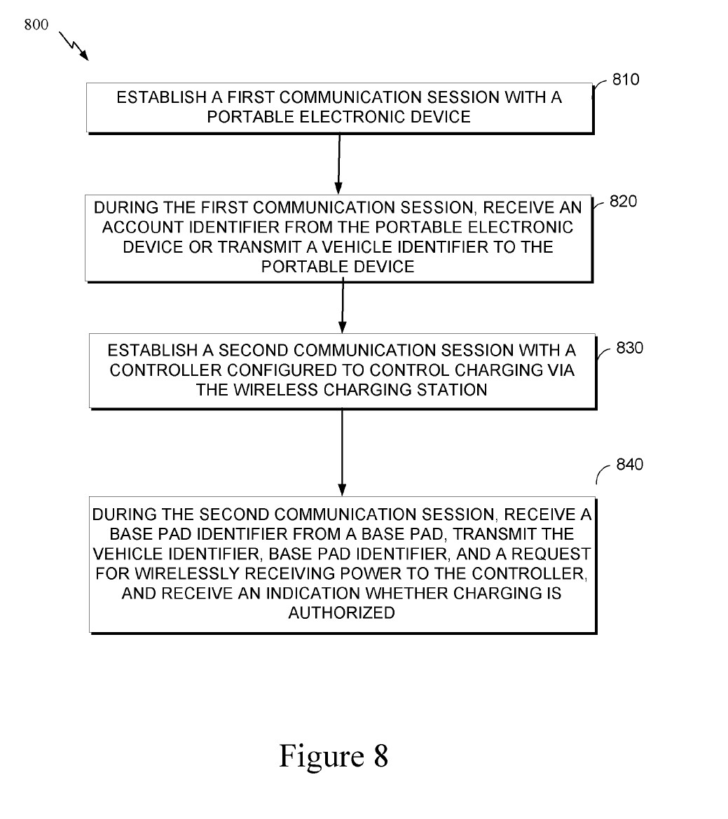

FIG. 8 illustrates a flowchart 800 of an exemplary method of authenticating a vehicle for wirelessly receiving power from a wireless charging station. A person having ordinary skill in the art will appreciate that the method of flowchart 800 may be implemented by any device described herein, or any other suitable device. In an embodiment, the blocks in flowchart 800 may be performed by a processor or controller such as, for example, the electric vehicle controller (FIG. 3). Although the method of flowchart 800 is described herein with reference to a particular order, in various embodiments, blocks herein may be performed in a different order, or omitted, and additional blocks may be added.

First, at block 810, an electric vehicle (e.g., the electric vehicle 412) establishes a first communication session with a portable electronic device. The electric vehicle 412 may establish the first communication session via a communication link such as, for example, an RFID, WiFi, Bluetooth, or other link. At block 820, during the first communication session, the electric vehicle 412 either receives an account ID from a portable electronic device (e.g., portable device 402) or transmits a vehicle ID to the portable device. At block 830, the electric vehicle 412 establishes a second communication session with a controller configured to control charging via the wireless charging station. At block 840, during the second communication session, the electric vehicle 412 receives a base pad ID from a base pad, transmits the vehicle ID, base pad ID, and a request for wirelessly receiving power to the controller, and receives an indication whether charging is authorized based on transmitting the request, base pad ID, and the vehicle ID, the authorization based at least in part on the account ID associated with the vehicle ID during the first communication session.

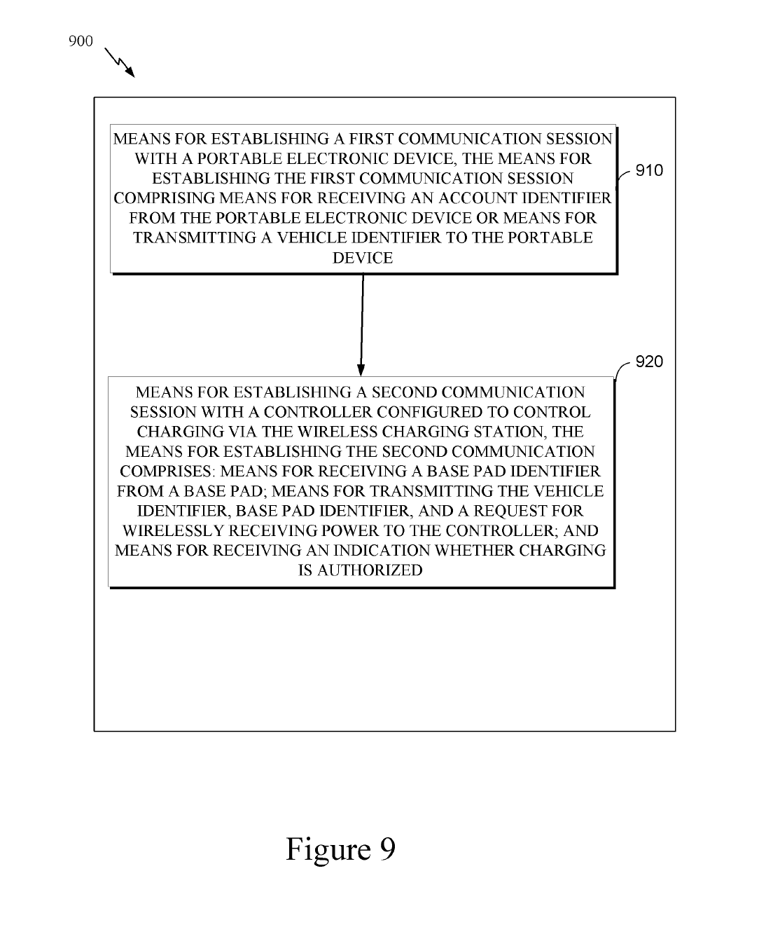

FIG. 9 is a functional block diagram of a wireless power apparatus 900, in accordance with an exemplary embodiment of the invention. Those skilled in the art will appreciate that a wireless power apparatus may have more components than the simplified wireless communication device 900 shown in FIG. 9. The wireless power apparatus 900 shown includes only those components useful for describing some prominent features of implementations within the scope of the claims.

The wireless power apparatus 900 includes means 910 for establishing a first communication session with a portable electronic device, the means for establishing the first communication session comprising means for receiving an account identifier from the portable electronic device or means for transmitting a vehicle identifier to the portable device. In an embodiment, the means 910 for establishing can be configured to perform one or more of the functions described above with respect to blocks 810 and 820 (FIG. 8). In various embodiments, the means 910 for establishing can be implemented by one or more of the antenna 140 (FIG. 1) and the EVCC 374 (FIG. 3). In some embodiments, the means for establishing the first communication may comprise a means for receiving an account identifier from the portable electronic device or means for transmitting a vehicle identifier of an electric vehicle to the portable device, during the first communication session. In some embodiments, the means for receiving may comprise a set of steps performed on a general purpose computer. For example, the computer may receive a message comprising information indicative of an account ID. The computer may then decode the message in order to obtain the account ID. In some embodiments, the means for transmitting may comprise steps performed on a general purpose computer. For example, the computer may retrieve a vehicle ID from data stored in the memory of the computer. The computer may then transmit the vehicle ID to a device via a communication link (e.g., WiFi, Bluetooth, Ethernet, etc.).

The wireless power apparatus 900 further includes means 920 for establishing a second communication session with a controller configured to control charging via the wireless charging station, the means for establishing the second communication comprises: means for receiving a base pad identifier from a base pad; means for transmitting the vehicle identifier, base pad identifier, and a request for wirelessly receiving power to the controller; and means for receiving an indication whether charging is authorized. In some embodiments, the apparatus 900 can be configured to perform one or more of the functions described above with respect to blocks 830 and 840 (FIG. 8). In various embodiments, the means 920 for establishing the second communication session establishing can be implemented by one or more of the antenna 140 (FIG. 1) and the EVCC 374 (FIG. 3). In some embodiments, means for establishing a second communication session may comprise means for receiving a base pad identifier from a base pad, means for transmitting the vehicle identifier, base pad identifier, and a request for wirelessly receiving power to the controller, and means for receiving an indication whether charging is authorized.

In some embodiments, the means for receiving a base pad ID may comprise a set of steps performed on a general purpose computer. For example, the computer may receive a message comprising information indicative of a base pad ID. The computer may then decode the message in order to obtain the base pad ID. In some embodiments, the means for transmitting may comprise steps performed on a general purpose computer. For example, the computer may retrieve the vehicle ID, base pad ID, and charging request from data stored in the memory of the computer. The computer may then transmit the vehicle ID, base pad ID, and charging request to a device via a communication link (e.g., WiFi, Bluetooth, Ethernet, etc.). In some embodiments, the means for receiving an indication may comprise a set of steps performed on a general purpose computer. For example, the computer may receive a message comprising information indicating whether charging is authorized. In some embodiments, the indication may comprise a bit in a field of the message. The computer may then decode the message in order to obtain the indication.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality may be implemented in varying ways for each particular application, but such implementation decisions should not be interpreted as causing a departure from the scope of the embodiments of the invention.

The various illustrative blocks, modules, and circuits described in connection with the embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm and functions described in connection with the embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art. A storage medium is coupled to the processor such that the processor can read information from, and write information to, the storage medium. In the alternative, the storage medium may be integral to the processor. Disk and disc, as used herein, includes compact disc (CD), laser disc, optical disc, digital versatile disc (DVD), floppy disk and blu ray disc where disks usually reproduce data magnetically, while discs reproduce data optically with lasers. Combinations of the above should also be included within the scope of computer readable media. The processor and the storage medium may reside in an ASIC. The ASIC may reside in a user terminal. In the alternative, the processor and the storage medium may reside as discrete components in a user terminal.

For purposes of summarizing the disclosure, certain aspects, advantages and novel features of the inventions have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

Various modifications of the above described embodiments will be readily apparent, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method of authenticating an electric vehicle for wirelessly receiving power from a wireless charging station, the method comprising:
establishing a first communication session with a portable electronic device, wherein during the first communication session, the method includes:
receiving an account identifier from the portable electronic device; or transmitting a vehicle identifier of the electric vehicle to the portable device; and
establishing a second communication session with a controller configured to control charging via the wireless charging station, wherein during the second communication session, the method includes:
receiving a base pad identifier from a base pad;
transmitting the vehicle identifier, base pad identifier, and a request for wirelessly receiving power to the controller; and
receiving an indication whether charging is authorized based on transmitting the request, the base pad identifier, and the vehicle identifier, the authorization based at least in part on the account identifier associated with the vehicle identifier as a result of information exchanged during the first communication session.

2. The method of claim 1, wherein during the second communication session the method further includes transmitting the account identifier to the controller.

3. The method of claim 2, wherein receiving an indication is based at least in part on the account identifier associated with the vehicle identifier as a result of information exchanged during the first communication session.

4. The method of claim 1, wherein establishing a first communication session comprises establishing a first communication session via a first wireless communication link.

5. The method of claim 3, wherein establishing the second communication session comprises establishing the second communication session via a second wireless communication link.

6. The method of claim 5, wherein the first communication link and the second communication link are the same.

7. The method of claim 1, wherein during the first communication session the method further includes receiving the account identifier from a user interface of the electric vehicle.

8. The method of claim 1, further comprising receiving wireless power sufficient to charge a battery of the electric vehicle from the base pad identified by the base pad identifier.

9. The method of claim 1, wherein during the first communication session the method further includes storing the account identifier in a memory of the electric vehicle.

10. An apparatus for receiving wireless power, comprising:
a receiver comprising one or more coils configured to receive wireless power sufficient to charge or power a battery from a charging station via a magnetic field; and
a transceiver configured to:
establish a first communication session with a portable electronic device, the transceiver further configured to receive an account identifier from the portable electronic device or transmit a vehicle identifier of an electric vehicle to the portable device, during the first communication session; and
establish a second communication session with a controller configured to control charging via the wireless charging station, the transceiver further configured to receive a base pad identifier from a base pad, transmit the vehicle identifier, base pad identifier, and a request for wirelessly receiving power to the controller, and receive an indication whether charging is authorized.

11. The apparatus of claim 10, wherein during the second communication session the transceiver is further configured to transmit the account identifier to the controller.

12. The apparatus of claim 10, wherein the transceiver is further configured to establish the first communication session via a first wireless communication link.

13. The apparatus of claim 12, wherein the transceiver is further configured to establish the second communication session via a second wireless communication link.

14. The apparatus of claim 13, wherein the first communication link and the second communication link are the same.

15. The apparatus of claim 10, wherein during the first communication session the transceiver is further configured to receive the account identifier from a user interface of the electric vehicle.

16. The apparatus of claim 10, further comprising a memory, wherein during the first communication session the memory is configured to store the account identifier.

17. An apparatus for charging an electric vehicle, comprising:
means for establishing a first communication session with a portable electronic device, the means for establishing the first communication session comprising:
means for receiving an account identifier from the portable electronic device; or
means for transmitting a vehicle identifier of the electric vehicle to the portable device, during the first communication session; and
means for establishing a second communication session with a controller configured to control charging via the wireless charging station, the means for establishing the second communication session comprising:
means for receiving a base pad identifier from a base pad;
means for transmitting the vehicle identifier, base pad identifier, and a request for wirelessly receiving power to the controller; and
means for receiving an indication whether charging is authorized.

18. The apparatus of claim 17, wherein means for establishing the second communication session further comprises means for transmitting the account identifier to the controller during the second communication session.

19. The apparatus of claim 17, wherein means for establishing the first communication session further comprises means for receiving the account identifier from a user interface of the electric vehicle.

20. The apparatus of claim 17, further comprising means for storing the account identifier.
